(19) United States
(12) Patent Application Publication
(10) Pub. No.: US 2026/0024449 A1
(43) Pub. Date: Jan. 22, 2026

(54) AI-DRIVEN READING PASSAGE GENERATION USING INTEGRATED PROGRAMMATIC CONTROL AND SPECIALIZED GUIDED AND CONSTRAINED ARTIFICIAL INTELLIGENCE

(71) Applicant: 2hr Learning, Inc., Austin, TX (US)

(72) Inventor: Simon Said, Malta (MA)

(73) Assignee: 2hr Learning, Inc., Austin, TX (US)

(21) Appl. No.: 19/273,085

(22) Filed: Jul. 17, 2025

Related U.S. Application Data
(60) Provisional application No. 63/672,430, filed on Jul. 17, 2024.

(51) Int. Cl. G09B 5/02; G09B 7/06; G09B 17/00

(52) U.S. Cl. CPC G09B 5/02; G09B 7/06; G09B 17/003

(57) ABSTRACT

A programmatically controlled and guided and constrained Artificial Intelligence (AI) engine reading passage generation system and method for guiding the AI engine in generating personalized reading passages for users using an online learning platform is disclosed. The method involves collecting user details, including interests, reading level, academic standards, and optional fictional attributes, from the user's profile. Based on the user's genre preference and reading level, the reading passage generation system selects an appropriate prompt structure from a repository. The collected data is then analyzed to generate insights, which are used to populate the selected prompt structure. The resulting prompts are transferred to the AI engine, guiding it to generate a reading passage that aligns with the user's interests, reading level, and age appropriateness. The final output includes not only the personalized passage but also multiple-choice questions (MCQs), a title, and an associated image, enhancing the overall educational experience.

### CROSS-REFERENCE TO RELATED APPLICATION(S)

This application claims the benefit under 35 U.S.C. § 119 (e) and 37 C.F.R. § 1.78 of U.S. Provisional Application No. 63/672,430, which is incorporated by reference in its entirety.

### FIELD OF THE INVENTION

The present invention generally relates to the field of electronics, and more specifically to generating an engaging, personalized, and dynamic reading passage by utilizing Artificial Intelligence (AI) for the user using an online learning platform based on the user's interests, reading level of the user, and age appropriateness of the user.

### BACKGROUND

Traditional reading applications, while offering a variety of content aligned with reading levels, often fall short of truly engaging students. These platforms typically include features like annotations, dictionaries, and read-aloud functions, as well as various question types to test student comprehension. However, the content they provide is pre-generated and cannot dynamically adapt to a student's evolving interests or performance. This static nature can lead to a one-size-fits-all approach, which may not effectively address the diverse needs of each learner.

Another significant drawback is the lack of engagement. Without dynamic content generation, these platforms may struggle to maintain a student's interest over time. The absence of content that evolves with the user means that students might find the material repetitive or not challenging enough, which can hinder their learning progress. Engaging students in a way that both challenges and interests them is crucial for effective learning, something that traditional platforms often fail to achieve.

Conventionally some applications offer a more interactive experience by allowing students to personalize elements of a story, such as the main character and plot. The customization options are predefined. Ultimately, both traditional reading applications and reading tools share a common shortfall, i.e., they do not provide ongoing, adaptive personalization that responds to a student's changing needs. Whether it's static content that fails to evolve with the learner.

### SUMMARY

In at least one embodiment, a method integrates programmatic control and a guided and constrained Artificial Intelligence (AI) engine to generate a personalized reading passage for a user using an online learning platform. The method includes executing code using one or more processors of a computer system to cause the computer system to perform operations. The operations include collecting user details from a user profile and optional fictional attributes inputted by the user while using the online learning platform, where the user details include user interests, user reading level, and academic standard of the user for age appropriateness. The operations include analyzing the collected user details and optional fictional attributes and generating insights. The operations include selecting a prompt structure from a prompt structure repository based on the genre and the reading level of the user. The operations include generating prompts by populating the selected prompt structure by utilizing the analyzed insights to guide the AI engine to generate the reading passage. The operations include transferring the generated prompts to the AI engine to generate the reading passage based on user interests, reading level, age appropriateness, and optional fictional attributes. The operations include generating the personalized reading passage along with multiple-choice questions, a title for the reading passage, and an associated image for the reading passage.

In at least one embodiment, a system integrates programmatic control and a guided and constrained Artificial Intelligence (AI) engine to generate a personalized reading passage for a user using an online learning platform. The system includes one or more processors of a computer system and a memory, coupled to the one or more processors, storing code that, when executed, causes the computer system to perform operations. The operations include collecting user details from a user profile and optional fictional attributes inputted by the user while using the online learning platform using a data collector, where the user details include user interests, user reading level, and academic standard of the user for age appropriateness. The operations include analyzing the collected user details and optional fictional attributes and generating insights using an analyzer. The operations include selecting a prompt structure from a prompt structure repository using a selector based on the genre and the reading level of the user. The operations include generating prompts using a prompt generator by populating the selected prompt structure by utilizing the analyzed insights to guide the AI engine to generate the reading passage. The operations include transferring the generated prompts to the AI engine to generate the reading passage based on user interests, reading level, age appropriateness, and optional fictional attributes. The operations include generating the personalized reading passage using a passage generator, along with multiple-choice questions, a title for the reading passage, and an associated image for the reading passage.

### BRIEF DESCRIPTION OF THE DRAWINGS

The systems and methods described herein may be better understood, and their numerous objects, features, and advantages are made apparent to those skilled in the art by referencing exemplary embodiments depicted in the accompanying figures. The use of the same reference number throughout the several figures designates a like or similar element.

FIG. 1 depicts an exemplary AI-driven reading passage generation system for a user using an online learning platform.

FIG. 2 depicts an exemplary AI-driven reading passage generation process for a user using an online learning platform.

FIG. 3 depicts a flowchart disclosing the steps of generation of a passage for a user in an online learning platform.

FIG. 4 depicts an exemplary reading passage displaying process to the user using an online learning platform, which is an embodiment of the AI-driven reading passage generation process of FIG. 2.

FIG. 5 depicts an exemplary user interface disclosing the front page of the online learning platform.

FIGS. 5-9 depict exemplary user interfaces that disclose the different types of genres, characters, settings, and any other special requests, which can be selected by the user for the generation of the personalized reading passage.

FIG. 10 depicts an exemplary user interface disclosing the generated reading passage for the user using an online learning platform.

FIG. 11 depicts an exemplary user interface that discloses the collection of reading passages generated by the user.

FIG. 12 depicts an exemplary user interface disclosing the edit profile option using which the user can make changes in the details given in the user profile.

FIG. 13 depicts an exemplary user interface disclosing the areas of interest, which can be selected by the user for the generation of the personalized reading passage.

FIG. 14 depicts a data structure for organizing data to populate the prompt structure based on various inputs.

FIG. 15 depicts an exemplary network environment in which the system of FIG. 1 and the process of FIG. 2 may be practiced.

FIG. 16 depicts an exemplary computer system.

### DETAILED DESCRIPTION

An AI-driven reading passage generation system and method for guiding an Artificial Intelligence (AI) engine in generating personalized reading passages for users using an online learning platform is disclosed. The AI-driven reading passage generation system includes the online learning platform which is operatively coupled to a passage generation planner. A data collector is integrated within the passage generation planner and is configured to collect the data from user profiles present in memory of the online learning platform. The data collector fetches data, including user profile details, and fictional attributes which are optional. The user profile details include user interest, user reading level, and academic standard of the user for age appropriateness. The collected data is then analyzed to generate insights using an analyzer, which is then used to populate the prompt structure generated by a prompt engineer. A selector selects the prompt structure based on the user's interests, reading level, and genre.

The insights generated by the analyzer are then used by a prompt generator to populate the prompt structure. The prompt generator utilizes NLP to generate the prompt and guide the AI engine to generate a personalized reading passage. The generated prompts are then transferred to the AI engine to generate the personalized reading passage using a passage generator. The passage generator along with the personalized reading passage, also generates a set of MCQ (Multiple Choice Questions), answers, and a photorealistic image in correspondence to the reading passage.

The advantage of the AI-driven reading passage generation system lies in its ability to deliver highly personalized and engaging reading experiences in correspondence to each user's unique interests, reading level, and age appropriateness. By utilizing AI and real-time feedback, the AI-driven reading passage generation system generates passages that align with the user's preferences and adapt to their learning needs. This dynamic approach enhances comprehension, maintains motivation, and provides continuous learning and engagement. Additionally, the integration of photorealistic images and interactive questions further enriches the educational experience, making it more immersive and effective. Ultimately, the AI-driven reading passage generation system empowers users to improve their reading skills in an enjoyable and academically beneficial way.

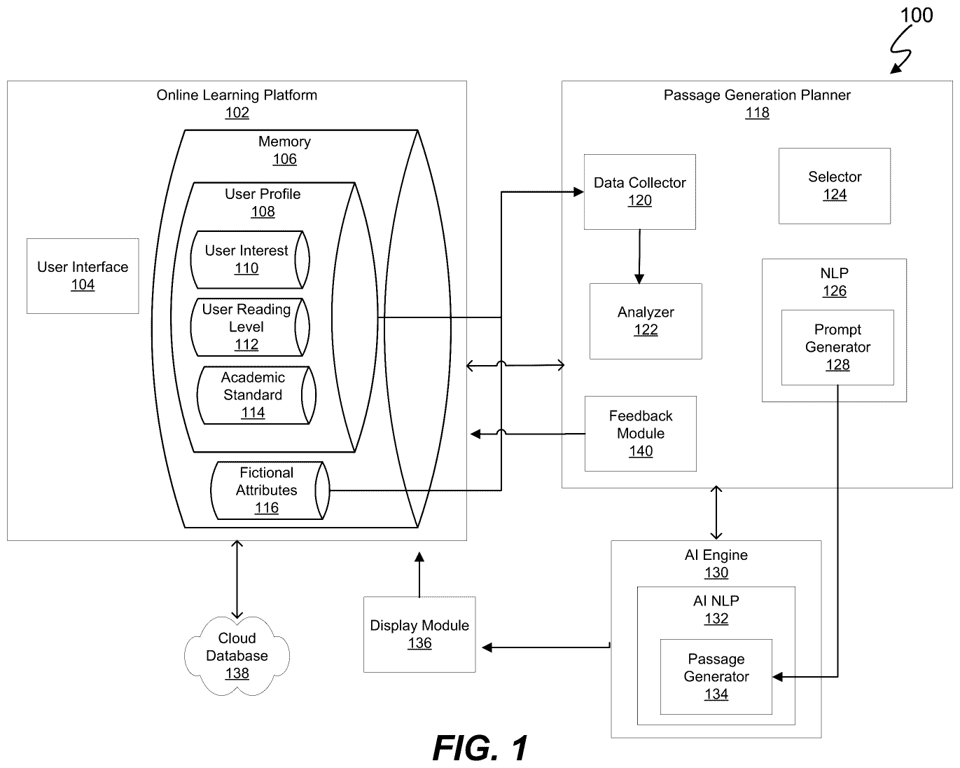

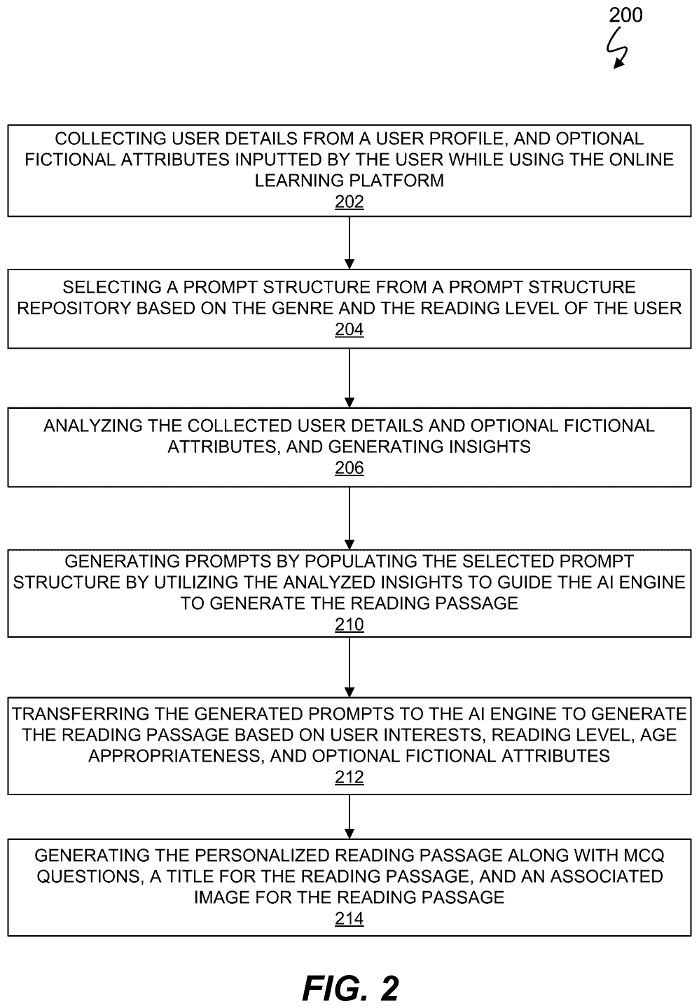

FIG. 1 depicts an exemplary AI-driven reading passage generation system 100 for a user using an online learning platform 102. FIG. 2 depicts an exemplary AI-driven reading passage generation process 200 for a user using an online learning platform 100 utilized by the AI-driven reading passage generation system 100.

Referring to FIGS. 1 and 2, in operation 202, a data collector 120 collects user details from a user profile 108, and optional fictional attributes 116 inputted by the user while using the online learning platform 102. The user details include user interests 110, user reading level 112, and academic standard 114 of the user for age appropriateness.

The data collector 120 is integrated within a passage generation planner 118, which is operatively coupled to the online learning platform 102. The data collector 120 fetches the data from a user profile 108 present in memory 106 of the online learning platform 102, and the fictional attributes 116, which are optional. The user profile 108 includes the user interests 110, user reading level 112, and academic standard 114 of the user for age appropriateness. The optional fictional attributes 116 inputted by the user while using the online learning platform 102 include settings related to location and environment, characters, plot, and twist.

The user profile 108 is a crucial element within the memory 106 of the online learning platform 102, designed to capture and organize key information that personalizes the reading experience for each user. The user profile 108 includes three main components, namely, user interests 110, user reading level 112, and academic standard 114. The user interests 110 incorporates the specific topics or themes that the user is particularly interested in, such as science, history, or fantasy.

The user reading level 112 refers to the user's current ability to understand and process written material, often measured by standardized metrics like Lexile scores. This information helps the online learning platform 102 match reading passages to the user's comprehension level, ensuring that the content is appropriately challenging and supportive of their reading development. The academic standard 114 takes into account the age-appropriateness of the content, aligning it with the educational standards relevant to the user's grade level or age group, thus ensuring that the material is both suitable and educationally valuable.

Additionally, the memory 108 of the online learning platform 102 may include optional fictional attributes 116 that the user can input while using the online learning platform 102. These attributes allow further customization of the reading experience, enabling the user to specify details such as settings related to location and environment, the types of characters they prefer, the plot structure, and any desired plot twists. By integrating these fictional attributes, the online learning platform 102 can generate stories that not only match the user's interests 110 and reading level 112 but also provide their narrative preferences, creating a more immersive and enjoyable reading experience.

The user's reading level 112 is initially set by default according to their age, which serves as a baseline for determining the appropriate reading material. This default setting is based on the academic standards that correspond to the user's age group, ensuring that the reading level aligns with typical educational expectations for their grade or developmental stage.

In operation 204, an analyzer 122 analyzes the collected user details and the optional fictional attributes 116 to generate insights.

The passage generation planner 118 further includes the component named analyzer 122 integrated within it to analyze the collected data and generate insights. These insights are useful for prompt generation. The analyzer 122 uses natural language processing techniques to analyze the collected data and generate insights.

The data collector 120 updates the user's details in real-time based on their interactions with the online learning platform 102. As the user engages with various reading passages or answers questions, the data collector 120 tracks and analyzes these activities using the analyzer 122. This real-time data collection allows the AI-driven reading passage generation system 100 to dynamically adjust the user's profile 108, including the user's interests 110, reading level 112, and academic standard 114. By keeping the user details up-to-date with their ongoing interactions, the online learning platform 102 can offer increasingly personalized reading passages that adapt to the user's evolving needs and abilities, enhancing the overall learning experience.

In operation 206, a selector 124 selects a prompt structure from a prompt structure repository 142 based on the genre and the reading level of the user.

The prompt structures are stored in the prompt structure repository 142. The prompt structure repository 142 is organized into categories based on both genre and user reading level 112, ensuring that the generated reading passage is in correspondence with the user's preferences and abilities. When generating personalized reading passages, the selector 124 accesses the prompt structure repository 142 and chooses a prompt structure that aligns with the user's genre preference, such as fiction or nonfiction and matches their reading level 112, ensuring the passage is appropriate and engaging.

A prompt structure includes constraints and guidelines to generate a fully populated prompt. The prompt with constraints and guidelines along is used by the prompt generator 128, which retrieves the analyzed data from the analyzer 122 and populates the prompt structure to generate a prompt:

CONTEXT
--------
You are a best-selling writer of stories that students in grade 5
love. Your stories ALWAYS have a Lexile of 920L.
Your reader has selected a Genre and Interest to tailor the story
to their preferences. They may also have selected story
specifications, including Setting, Main Character, Supporting
Character, Plot Archetype, and/or Plot Twist. It's crucial that
you align your story closely with all included Inputs to engage
your reader fully.
EXAMPLES
--------
These are the characteristics of passages with a Lexile of 920L:

| | |
|---|---|
| - | Use primarily contemporary, familiar, conversational |

vocabulary.

| | |
|---|---|
| - | Use only short simple sentences, medium simple sentences, short |

compound sentences, and medium compound sentences.

| | |
|---|---|
| - | Connect some ideas or events implicitly or subtly. |
| - | Generally use sequential or chronological organization. |
| - | Imply the purpose but ensure it is easy to identify based on |

context or source.

| | |
|---|---|
| - | Rely on common practical knowledge and only some discipline- |

specific content knowledge.

| | |
|---|---|
| - | Include a mix of simple and more abstract ideas. |

Sentence type examples
These are examples of the sentence types:

| | |
|---|---|
| - | short simple sentence: ″The cat sleeps.″ |
| - | medium simple sentence: ″The bright sun warmed the sandy |

beach.″

| | |
|---|---|
| - | long simple sentence: ″The old, towering oak tree in the heart |

of the forest swayed gently in the autumn breeze.″

| | |
|---|---|
| - | short compound sentence: ″I tried calling, but no one |

answered.″

| | |
|---|---|
| - | medium compound sentence: ″She finished her work, and then she |

went out for a walk.″

| | |
|---|---|
| - | long compound sentence: ″The team played well in the first |

half, but they lost focus after the break, resulting in a
dramatic loss.″

| | |
|---|---|
| - | short complex sentence: ″Although tired, he continued working.″ |
| - | medium complex sentence: ″While the sun sets, the city lights |

begin to twinkle, creating a beautiful scene.″

| | |
|---|---|
| - | long complex sentence: ″The dog, who had been sleeping all day, |

suddenly perked up when he heard his owner's car pull into the
driveway.″

| | |
|---|---|
| - | short compound-complex sentence: ″I fell asleep while reading, |

and my book dropped to the floor.″

| | |
|---|---|
| - | medium compound-complex sentence: ″When the bell rang, the |

students rushed out, and the hallways were immediately filled
with noise.″

| | |
|---|---|
| - | long compound-complex sentence: ″As the orchestra began to |

play, the audience quieted down, and the soloist, feeling a bit
nervous, took a deep breath before starting her performance.″
Fiction passage examples
These fiction passages both have a Lexile of 920L:
<
The Long Night
“You're not the only one,” Bobby's father said as he drove their
car very slowly and carefully through the empty streets. In spite
of the fact that there were no other vehicles on the road,
driving was still dangerous in this situation: his dad could
hardly keep his eyes open. “There are at least a dozen other
people in this part of the state who haven't responded to the
Hibernation Instinct.”
Bobby's mother hugged him with one arm while resting her head
atop his own. For a moment, he thought that she had slipped off
to sleep, but then she said in a warm, drowsy voice, “We thought
that you would be... affected like your brother and sister. But,
well, you've always been your own little man, haven't you?” She
gave him a sloppy kiss at the temple.
[...]
“Wow,” Bobby whispered when his thoughts were clear enough to say
anything again. “I did it. I saved the world. Robert Arthur
Jackson, Defender of the Earth and All the People Who Live on
It.” It sounded good.
If anyone would believe him.
“And I'll be ready for the next six months, if you decide to try
again!” He laughed at the stars.
Then he trotted back to the elevator and the cafeteria several
floors below. Even heroes had to eat.
>
<
Dragon, Dragon
There was once a king whose kingdom was plagued by a dragon. The
king did not know which way to turn. The king's knights were all
cowards who hid under their beds whenever the dragon came in
sight, so they were of no use to the king at all. And the king's
wizard could not help either because, being old, he had forgotten
his magic spells. Nor could the wizard look up the spells that
had slipped his mind, for he had unfortunately misplaced his
wizard's book many years before. The king was at his wit's end.
Every time there was a full moon the dragon came out of his lair
and ravaged the countryside. He frightened maidens and stopped up
chimneys and broke store windows and set people's clocks back and
made dogs bark until no one could hear himself think.
He tipped over fences and robbed graves and put frogs in people's
drinking water and tore the last chapters out of novels and
changed house numbers around so that people crawled into bed with
their neighbors.
[...]
“My wizard's book!” exclaimed the wizard. “He's found my wizard's
book!” He opened the book and ran his finger along under the
words and then said in a loud voice, “Glmuzk, shkzmlp, blam!”
Instantly the queen stood before them in her natural shape,
except she was soaking wet from being sprinkled too often. She
glared at the king.
“Oh dear,” said the king, hurrying toward the door.
>
TASKS
--------

| | |
|---|---|
| 1. | Review the Core Inputs to understand your reader's vital |

Lexile needs and story preferences.

| | |
|---|---|
| 2. | Study the Examples section to learn how to generate a story |

with a Lexile of 920L.

| | |
|---|---|
| 3. | Write a Genre: Science Fiction story that focuses on Birds. |

Ensure that the story has a plot that is appropriate and engaging
for readers in grade 5.

| | |
|---|---|
| 4. | Refer to the Story Specifications section of the Rules and |

follow all rules to tailor the story to the reader's preferences.

| | |
|---|---|
| 5. | Ensure the Lexile is maintained from start to finish so that |

an excerpt pulled from the passage is still at a Lexile of 920L.

| | |
|---|---|
| 6. | Generate a passage title that follows the style of titles for |

the story's genre.

| | |
|---|---|
| 7. | Generate a concise, one-sentence story description to |

captivate potential readers. This description must NOT reference
Student Grade at all. This description must never give away the
passage's resolution or theme. This description is a teaser that
draws in potential readers.
RULES
--------

| | |
|---|---|
| * | MOST crucially, the story must have a Lexile of 920L. |
| * | Apply the Lexile characteristics to ensure your story has the |

needed Lexile.

| | |
|---|---|
| * | Use the Sentence type examples to further ensure your story has |

the needed Lexile. Sentence length is a key determiner of Lexile.

| | |
|---|---|
| * | Use the Fiction passage examples as models to ensure your story |

has the needed Lexile.

| | |
|---|---|
| * | The story must be long enough to have a full and engaging story |

arc that does not feel rushed or underdeveloped. Allow enough
time for character development, conflict development, a
compelling climax, and an engaging resolution. Lengthy stories
are entirely acceptable.

| | |
|---|---|
| * | The resolution can be nuanced or straightforward. It must never |

feel rushed. The complexity of the story's resolution must be
appropriate for its genre and the Student Grade.

| | |
|---|---|
| * | The story must be extremely engaging for a student in grade 5 |

who chose the genre of Genre: Science Fiction and is interested
in Birds.

| | |
|---|---|
| * | The story must always follow all American grammar and |

punctuation conventions.

| | |
|---|---|
| * | The story must always use only American spelling conventions. |
| * | Do not begin your stories with “once upon a time.” |
| * | The story must be presented in newline-delimited text format, |

with each new paragraph separated by a newline character (
).
Story Specifications
Output Template
------

| | |
|---|---|
| * | Passage Title: The title of the nonfiction passage generated. |
| * | Passage Description: A short description of the nonfiction |

passage generated.

| | |
|---|---|
| * | Passage Text: The body of the generated nonfiction passage. |

Output Format
------
Format your response in valid JSON format with the following
fields:
{

```
  ″passage_title″: ″″,
  ″passage_description″: ″″,
  ″passage_text″: ″″
```

}
CORE INPUTS
--------
Student Grade:
Student Interest:
Lexile Level:
Genre:

In operation 208, the prompt generator 128 generates prompts by populating the selected prompt structure by utilizing the analyzed insights to guide the AI engine 130 to generate the reading passage.

The prompt generator 128 utilizes NLP techniques using a Natural Language Processor (NLP) 126 to generate prompts that are provided to the AI engine 130. The prompt generator 128 is operatively coupled to the passage generation planner 118 and generates the prompts based on the prompt structure selected by the selector 124 and the input data collected by the data collector 120. The prompt generator 128 is then used to populate the prompt structure selected by the selector 124, which then further guides the AI engine 130 to generate personalized reading passages for the user using the online learning platform 102.

The prompt generator utilizes the analyzed data from the analyzer 122 and uses the generated insights to populate the prompt structure selected by the selector 124 based on the details of the user profile 108 and genre.

The exemplary prompts transferred by the prompt generator 128 to the AI engine 130 is given below:

CONTEXT
--------
You are a best-selling writer of stories that students in grade 5
love. Your stories ALWAYS have a Lexile of 920L.
Your reader has selected a Genre and Interest to tailor the story
to their preferences. They may also have selected story
specifications, including Setting, Main Character, Supporting
Character, Plot Archetype, and/or Plot Twist. It's crucial that
you align your story closely with all included Inputs to engage
your reader fully.
EXAMPLES
--------
These are the characteristics of passages with a Lexile of 920L:

| | |
|---|---|
| - | Use primarily contemporary, familiar, conversational |

vocabulary.

| | |
|---|---|
| - | Use only short simple sentences, medium simple sentences, short |

compound sentences, and medium compound sentences.

| | |
|---|---|
| - | Connect some ideas or events implicitly or subtly. |
| - | Generally use sequential or chronological organization. |
| - | Imply the purpose but ensure it is easy to identify based on |

context or source.

| | |
|---|---|
| - | Rely on common practical knowledge and only some discipline- |

specific content knowledge.

| | |
|---|---|
| - | Include a mix of simple and more abstract ideas. |

Sentence type examples
These are examples of the sentence types:

| | |
|---|---|
| - | short simple sentence: ″The cat sleeps.″ |
| - | medium simple sentence: ″The bright sun warmed the sandy |

beach.″

| | |
|---|---|
| - | long simple sentence: ″The old, towering oak tree in the heart |

of the forest swayed gently in the autumn breeze.″

| | |
|---|---|
| - | short compound sentence: ″I tried calling, but no one |

answered.″

| | |
|---|---|
| - | medium compound sentence: ″She finished her work, and then she |

went out for a walk.″

| | |
|---|---|
| - | long compound sentence: ″The team played well in the first |

half, but they lost focus after the break, resulting in a
dramatic loss.″

| | |
|---|---|
| - | short complex sentence: ″Although tired, he continued working.″ |
| - | medium complex sentence: ″While the sun sets, the city lights |

begin to twinkle, creating a beautiful scene.″

| | |
|---|---|
| - | long complex sentence: ″The dog, who had been sleeping all day, |

suddenly perked up when he heard his owner's car pull into the
driveway.″

| | |
|---|---|
| - | short compound-complex sentence: ″I fell asleep while reading, |

and my book dropped to the floor.″

| | |
|---|---|
| - | medium compound-complex sentence: ″When the bell rang, the |

students rushed out, and the hallways were immediately filled
with noise.″

| | |
|---|---|
| - | long compound-complex sentence: ″As the orchestra began to |

play, the audience quieted down, and the soloist, feeling a bit
nervous, took a deep breath before starting her performance.″
Fiction passage examples
These fiction passages both have a Lexile of 920L:
<
The Long Night
“You're not the only one,” Bobby's father said as he drove their
car very slowly and carefully through the empty streets. In spite
of the fact that there were no other vehicles on the road,
driving was still dangerous in this situation: his dad could
hardly keep his eyes open. “There are at least a dozen other
people in this part of the state who haven't responded to the
Hibernation Instinct.”
Bobby's mother hugged him with one arm while resting her head
atop his own. For a moment, he thought that she had slipped off
to sleep, but then she said in a warm, drowsy voice, “We thought
that you would be... affected like your brother and sister. But,
well, you've always been your own little man, haven't you?” She
gave him a sloppy kiss on the temple.
[...]
“Wow,” Bobby whispered when his thoughts were clear enough to say
anything again. “I did it. I saved the world. Robert Arthur
Jackson, Defender of the Earth and All the People Who Live on
It.” It sounded good.
If anyone would believe him.
“And I'll be ready for the next six months, if you decide to try
again!” He laughed at the stars.
Then he trotted back to the elevator and the cafeteria several
floors below. Even heroes had to eat.
>
<
Dragon, Dragon
There was once a king whose kingdom was plagued by a dragon. The
king did not know which way to turn. The king's knights were all
cowards who hid under their beds whenever the dragon came in
sight, so they were of no use to the king at all. And the king's
wizard could not help either because, being old, he had forgotten
his magic spells. Nor could the wizard look up the spells that
had slipped his mind, for he had unfortunately misplaced his
wizard's book many years before. The king was at his wit's end.
Every time there was a full moon the dragon came out of his lair
and ravaged the countryside. He frightened maidens and stopped up
chimneys and broke store windows and set people's clocks back and
made dogs bark until no one could hear himself think.
He tipped over fences and robbed graves and put frogs in people's
drinking water and tore the last chapters out of novels and
changed house numbers around so that people crawled into bed with
their neighbors.
[...]
“My wizard's book!” exclaimed the wizard. “He's found my wizard's
book!” He opened the book and ran his finger along under the
words and then said in a loud voice, “Glmuzk, shkzmlp, blam!”
Instantly the queen stood before them in her natural shape,
except she was soaking wet from being sprinkled too often. She
glared at the king.
“Oh dear,” said the king, hurrying toward the door.
>
TASKS
--------

| | |
|---|---|
| 1. | Review the Core Inputs to understand your reader's vital |

Lexile needs and story preferences.

| | |
|---|---|
| 2. | Study the Examples section to learn how to generate a story |

with a Lexile of 920L.

| | |
|---|---|
| 3. | Write a Genre: Science Fiction story that focuses on Birds. |

Ensure that the story has a plot that is appropriate and engaging
for readers in grade 5.

| | |
|---|---|
| 4. | Refer to the Story Specifications section of the Rules and |

follow all rules to tailor the story to the reader's preferences.

| | |
|---|---|
| 5. | Ensure the Lexile is maintained from start to finish so that |

an excerpt pulled from the passage is still at a Lexile of 920L.

| | |
|---|---|
| 6. | Generate a passage title that follows the style of titles for |

the story's genre.

| | |
|---|---|
| 7. | Generate a concise, one-sentence story description to |

captivate potential readers. This description must NOT reference
Student Grade at all. This description must never give away the
passage's resolution or theme. This description is a teaser that
draws in potential readers.
RULES
--------

| | |
|---|---|
| * | MOST crucially, the story must have a Lexile of 920L. |
| * | Apply the Lexile characteristics to ensure your story has the |

needed Lexile.

| | |
|---|---|
| * | Use the Sentence type examples to further ensure your story has |

the needed Lexile. Sentence length is a key determiner of Lexile.

| | |
|---|---|
| * | Use the Fiction passage examples as models to ensure your story |

has the needed Lexile.

| | |
|---|---|
| * | The story must be long enough to have a full and engaging story |

arc that does not feel rushed or underdeveloped. Allow enough
time for character development, conflict development, a
compelling climax, and an engaging resolution. Lengthy stories
are entirely acceptable.

| | |
|---|---|
| * | The resolution can be nuanced or straightforward. It must never |

feel rushed. The complexity of the story's resolution must be
appropriate for its genre and the Student Grade.

| | |
|---|---|
| * | The story must be extremely engaging for a student in grade 5 |

who chose the genre of Genre: Science Fiction and is interested
in Birds.

| | |
|---|---|
| * | The story must always follow all American grammar and |

punctuation conventions.

| | |
|---|---|
| * | The story must always use only American spelling conventions. |
| * | Do not begin your stories with “once upon a time.” |
| * | The story must be presented in newline-delimited text format, |

with each new paragraph separated by a newline character (
).
Story Specifications
Output Template
------

| | |
|---|---|
| * | Passage Title: The title of the nonfiction passage generated. |
| * | Passage Description: A short description of the nonfiction |

passage generated.

| | |
|---|---|
| * | Passage Text: The body of the generated nonfiction passage. |

Output Format
------
Format your response in valid JSON format with the following
fields:
{

```
  ″passage_title″: ″″,
  ″passage_description″: ″″,
  ″passage_text″: ″″
```

}
CORE INPUTS
--------
Student Grade: 5
Student Interest: Birds
Lexile Level: 920L
Genre: Fiction

In operation 210, the prompt generator 128 transfers the generated prompt to the AI engine 130 to generate the reading passage based on user interests 110, reading level 112, age appropriateness, and optional fictional attributes 116.

The prompt generator 128 is operatively coupled to the AI engine 130 and transfers the generated prompts to the AI engine 130 to guide the AI engine 130 to generate the personalized reading passages for the user using the online learning platform 102. The AI engine 130 is operatively coupled to the passage generation planner 118.

The AI engine 130 utilizes natural language processing (NLP) to generate the passage of reading passages according to the user's specific preferences and their previous interactions with the online learning platform 102. By analyzing data such as the user's genre interests, reading level, and how they have responded to past content, the AI engine 130 dynamically adjusts the language, tone, and complexity of the passages. This allows the reading passage to be not only personalized to the user's current tastes and learning needs but also progressively aligned with their evolving reading abilities and interests, making the learning experience more engaging and effective.

In operation 212, a passage generator 134 generates the personalized reading passage, along with MCQ questions, a title for the reading passage, and an associated image for the reading passage.

The passage generator 134 utilizes AI NLP (Artificial Intelligence Natural Language Processor) 132 to generate the personalized reading passage for the user using the online learning platform 102. Along with the personalized reading passage, the MCQ questions, a title for the reading passage, and an associated image for the reading passage are also generated. The MCQ questions, a title for the reading passage, and an associated image for the reading passage generated are in correspondence with the context of the reading passage.

The generated reading passage is displayed to the user using a display module 136 on the user interface 104 of the online learning platform 102. The display module 136 is operatively coupled to the AI engine 130 and the online learning platform 102.

Personalizing the generated passage using machine learning algorithms involves a two-step process that ensures the content is closely aligned with the user's abilities and preferences. First, the AI engine 130 continuously tracks the user's reading performance, collecting data on how well the user interacts with and comprehends various reading materials. This tracking includes monitoring metrics such as reading speed, accuracy in answering comprehension questions, and the user's engagement level. Additionally, the AI engine 130 analyzes the genre and themes that capture the user's interest, identifying patterns in their content preferences, whether they fall towards science fiction, historical narratives, or fantasy, for example.

Second, based on this comprehensive analysis, the passage generator 134 generates a reading passage that not only aligns with the user's expressed interests but is also in correspondence with the appropriate complexity level that the user can handle. The machine learning algorithms dynamically adjust the difficulty of the text, ensuring that the passage challenges the user just enough to promote growth without causing frustration. The content is customized to fit within the user's preferred genre and themes while matching their current reading capabilities, making the learning experience both engaging and educationally effective. This personalized approach helps maintain the user's interest and supports their continued development in reading proficiency.

The online learning platform 102 is designed to continuously update the user's reading level as they interact with the content. Each time the user engages with a reading passage, their performance is monitored in real-time. This includes tracking how they navigate the passage, their reading speed, and how accurately they answer comprehension questions. Based on these interactions, the online learning platform 102 dynamically adjusts the user's reading level, ensuring that the difficulty of future content is always appropriately matched to their evolving abilities. This real-time adjustment is crucial for maintaining a balance between challenge and comprehension and provides continuous learning and improvement.

Once a reading passage is generated, it is stored in a cloud database 138, allowing for easy retrieval in the future. This storage ensures that the user can revisit previous passages, review their progress, and track their development over time. The cloud-based approach also supports scalability, enabling the online learning platform 102 to handle a large volume of content and users efficiently.

As the user continues to interact with the online learning platform 102, their reading level is not only updated continuously but also influenced by the answers they provide to the generated questions. These questions are specifically designed as multiple-choice questions (MCQs) that align with the key concepts presented in the passage. The MCQs serve as a tool to evaluate the user's comprehension and retention of the material. By analyzing the user's responses, the online learning platform 102 gains insights into their understanding of the passage, which further informs the real-time adjustment of their reading level. This ensures that the reading passages and questions are always in sync with the user's current capabilities, promoting a personalized and effective learning experience.

The output personalized reading passage along with the MCQ questions, answers, and images generated using the passage generator 134 is given below:

```
{
  ″passage_title″: ″The Aviary Chronicles″,
  ″passage_description″: ″In a distant future, a young inventor
and his clever pet bird embark on a mission to save their city
from mysterious malfunctioning drones.″,
  ″passage_text″: ″In the bustling city of Skylight, the sky
was always filled with drones zipping about, delivering packages
and assisting people. But one day, something went wrong. The
drones began flying erratically, crashing into buildings and
causing chaos.\n\nLucas, a young inventor, watched from his
workshop. His pet bird, Zephyr, perched on his shoulder, chirping
nervously. Zephyr was no ordinary bird; he was a brilliant avian
companion Lucas had trained since he was a chick.\n\n“We have to
do something, Zephyr,” Lucas said, patting the bird's head
gently. “Those drones are out of control, and they could hurt
someone.”\n\nZephyr fluttered his wings and flew to the large
window, looking out at the pandemonium. Lucas swiftly gathered
his tools, a couple of gadgets, and some snacks for Zephyr.
Together, they headed to the city's central drone command center,
hoping to find the source of the problem.\n\nWhen they arrived,
they found the building in disarray. Several drones were stuck in
the walls, and the control panels were sparking. Lucas
immediately got to work, analyzing the systems. Zephyr, with his
keen sight, noticed a small device attached to one of the main
consoles.\n\n“Good eye, Zephyr!” Lucas exclaimed as he carefully
removed the device. “This looks like a jammer. Someone must have
planted it here to disrupt the drones.” He quickly disabled the
jammer, and the chaotic buzzing of drones outside began to quiet
down. However, Lucas knew the city wasn't safe yet. They had to
find out who was behind this.\n\nUsing the signals from the
jammer, Lucas tracked the source back to an abandoned warehouse
on the outskirts of Skylight. With Zephyr leading the way, they
navigated through the city's winding streets and found themselves
at the warehouse.\n\nInside, a shadowy figure stood beside a
computer, surrounded by screens displaying live drone feeds. “So,
you found me,” the figure said, not turning around. “But you're
too late. The drones are only the beginning.”\n\nLucas wasn't
intimidated. “Zephyr, go!” he shouted. The bird flew at the
figure, knocking a small transmitter from their hands. Lucas
dashed forward, snatching the device off the floor.\n\n“You won't
get away with this,” Lucas said, disabling the transmitter. “The
city will be safe again.” The figure tried to escape, but Zephyr
swooped down, blocking their path until the authorities
arrived.\n\nBack at the command center, Lucas reprogrammed the
remaining drones, ensuring they would never be hijacked again.
His invention skills and Zephyr's intelligence had saved the
day.\n\nAs they walked home, Zephyr perching proudly on his
shoulder, Lucas smiled. “We make a pretty good team, don't we,
Zephyr?” The bird chirped in agreement, and together they looked
forward to their next adventure.″
}
```

The algorithm for passage generation used in the AI-driven reading passage generation system 100 for a user using an online learning platform 102 for converting the text-based prompt into a text-base passage is given below:

```
def generate_personalized_content(lexile, grade, interest, genre,
attributes):
  passage_prompt = fill_prompt_template(lexile, grade,
interest, genre, attributes)
  passage = gpt4_generate(prompt=passage_prompt)
  questions_prompt = fill_prompt_template(passage)
  questions = gpt4_generate(prompt=questions_prompt)
  image_prompt = fill_prompt_template(passage)
  image = dalle_generate(prompt=image_prompt)
  article = create_article(passage, questions, image)
  save_to_database(article)
  return article
```

The codes and functions mentioned in the pseudo-code of the AI-driven reading passage generation system 100 to generate the reading passage are explained below in correspondence to the above-mentioned details.

The algorithm provided above is used to convert the prompt to a personalized passage and includes a function ‘generate_personalized_content’ to create customized educational passages based on a user's Lexile level, grade, interests, and genre preferences. The passage generation takes place using a tool like GPT-4, in correspondence to defined parameters. Although not limited to GPT-4, other text-generating software can also be used.

Next, the algorithm produces related questions and an accompanying image by generating prompts based on the passage. Finally, it combines the passage, questions, and image into an article, saves it to the cloud database 138, and returns the finished article. This function integrates natural language generation and image generation to deliver personalized learning materials.

The AI-driven reading passage generation system 100 further includes a feedback module 140 which is operatively coupled to the online learning platform 102 and is integrated within the passage generation planner 118. The feedback module 140 is designed to provide real-time feedback to users based on their reading performance. The feedback module 140 operates by continuously monitoring and analyzing the user's interactions with the reading passage. As the user reads through a passage, or answers embedded questions, the feedback module 140 collects data on their performance, such as reading speed, accuracy in answering questions, comprehension levels, and engagement with the passage.

Using this data, the feedback module 140 assesses the user's understanding and proficiency in real-time and identifies areas where the user excels and areas that may require additional attention. Based on this analysis, the feedback module 140 generates personalized feedback that is immediately presented to the user.

By providing this real-time feedback, the feedback module 140 not only helps users track their progress but also enhances their learning experience by offering timely guidance and support. This dynamic interaction between the user and the online learning platform 102 via. the feedback module 140 ensures that the reading process is both adaptive and responsive to the user's needs, thereby providing continuous improvement and user engagement.

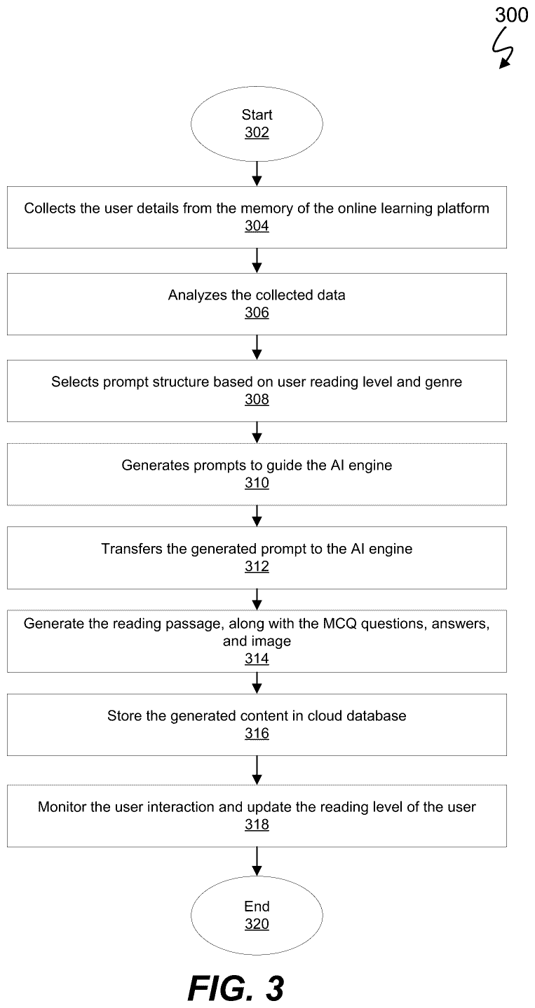

FIG. 3 depicts a flowchart 300 disclosing the steps of generation of a passage for a user in an online learning platform 102.

Initially, the user enters the online learning platform 102 to generate a passage 302. The process is initiated by the user using the online learning platform 102. The data collector 120 collects 304 user details 108 from the memory 106 of the online learning platform 102. This involves gathering crucial information, including the user's interests 110, reading level 112, academic standard 114, and any optional fictional attributes 116 the user may have specified. These details are essential for generating the reading passage according to the user's specific needs.

The collected data is analyzed 306 using an analyzer 122, which is integrated within the passage generation planner 118. The analyzer 122 processes and examines the user details to generate insights that will help in prompt generation. The selector 124 selects a prompt structure 308. The selection is made from a prompt structure repository 142, with the choice based on the user's genre preference and reading level. This step ensures that the generated content is appropriately structured and aligned with the user's interests.

Following this, the prompt generator 128 generates prompts 310 by populating the selected prompt structure with the insights obtained from the analysis, crafting a set of instructions to guide the AI engine 130.

The generated prompts are transferred 312 to the AI engine 130. The prompts guide the AI engine 130 in creating the personalized reading passage, ensuring that the content is in correspondence with the user's preferences and reading level. The passage generator 134 takes over to generate the reading passage 314. The passage generator 134 not only produces the text but also includes additional elements such as MCQ questions, a title, and an associated image, all of which are designed to enhance the user's engagement with the content.

Once the passage is generated, the content is stored 316 in a cloud database 138. This step ensures that the reading passage is saved securely for future retrieval, allowing the user to access the content whenever needed. Further, the AI engine 130 monitors 318 the user's interactions, where the reading level is updated in real-time based on the user's performance and engagement with the online learning platform 102. This ongoing adjustment ensures that the content remains appropriately challenging and relevant to the user's evolving reading abilities. Finally, the reading passage generation concludes 320, marking the end of the sequence. This step signifies the completion of the passage generation and adaptation process for the user's session on the online learning platform 102.

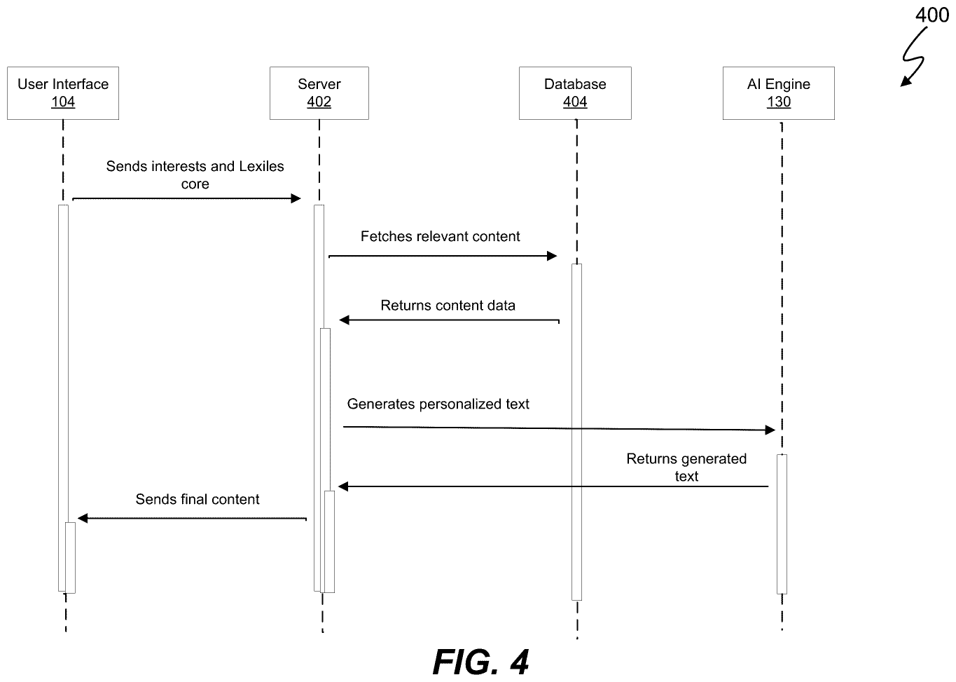

FIG. 4 depicts an exemplary reading passage displaying process 400 to the user using an online learning platform 102, which is an embodiment of the AI-driven reading passage generation process 200 of FIG. 2.

The reading passage displaying process 400 illustrates the interactions between various components of the online learning platform 102 when the user uses the online learning platform 102 to generate personalized reading passages. The reading passage displaying process 400 starts with the user inputting the user interests 110, reading level 112, and academic standard 114 into the online learning platform 102 via the user interface 104. The user can also enter details like fictional attributes 116, which is optional. This information is sent to the server 402, which is responsible for managing the user's request. The server 402 queries the database 404 to retrieve content that matches the user interests 110, reading level 112, and academic standard 114. The database 404 responds by providing relevant content data to the server. 402

Next, the server 402 communicates with an AI engine 130, sending it the retrieved content data along with instructions to generate personalized reading passages. The AI engine 130 processes the data, and generates the personalized reading passage that aligns with the user interests 110, reading level 112, and academic standard 114. The generated passage, which includes the main text, questions, and multimedia elements, is then sent back to server 402. Finally, server 402 delivers the personalized passage to the user interface 102 of the online learning platform 102, allowing the user to interact with the customized reading material.

The reading passage displaying process 400 would be clear from the following example. Consider a student named George who is fascinated by dinosaurs. He logs into the online learning platform 102 and specifies that his reading level is 600L. The online learning platform 102 processes this information, and the server 402 retrieves a relevant story from the database 404. The AI engine then crafts a story about a young dinosaur's adventure, embedding questions like “What did the dinosaur find in the forest?” and including images of dinosaurs and a video about fossil discovery. George reads the story and answers the questions, which helps him better understand and enjoy the content tailored to his interests and reading level.

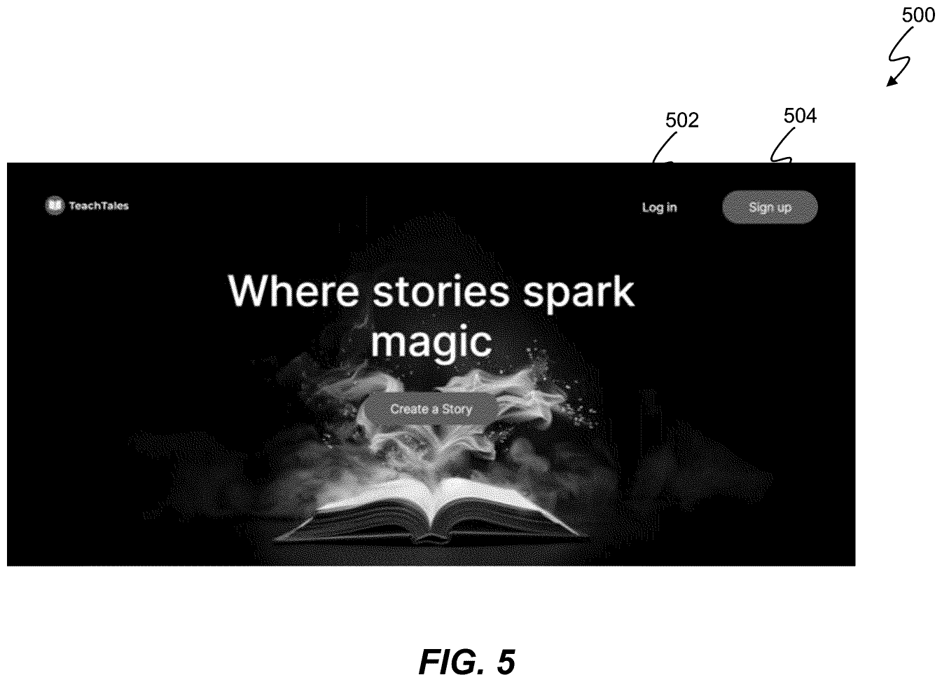

FIG. 5 depicts an exemplary user interface 500 disclosing the front page of the online learning platform 102.

The user interface 500 shows the front page of the online learning platform 102 using which the user can generate personalized passages. The user can click on the tab ‘Log in’ 502 to log in to the online learning platform 102 if the user is already registered to the online learning platform 102. However, if the user is not registered to the online learning platform 102, then the user may click on the tab ‘Sign Up’ 504 to sign up for the online learning platform 102. After successfully logging in or signing up, if the user wants to generate a passage, the user can click on the tab ‘Create a Story’ 506.

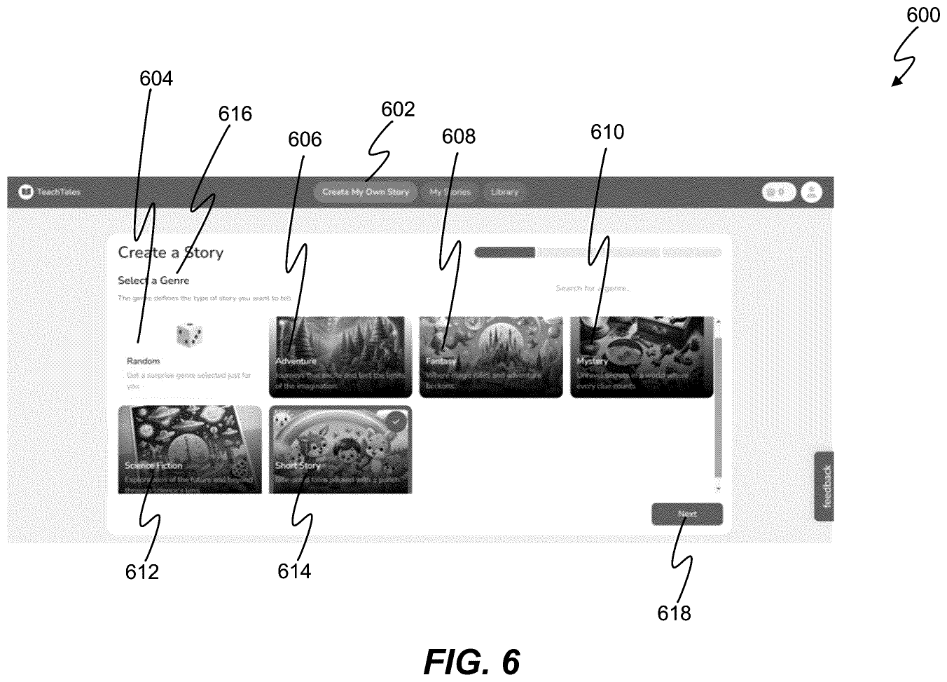

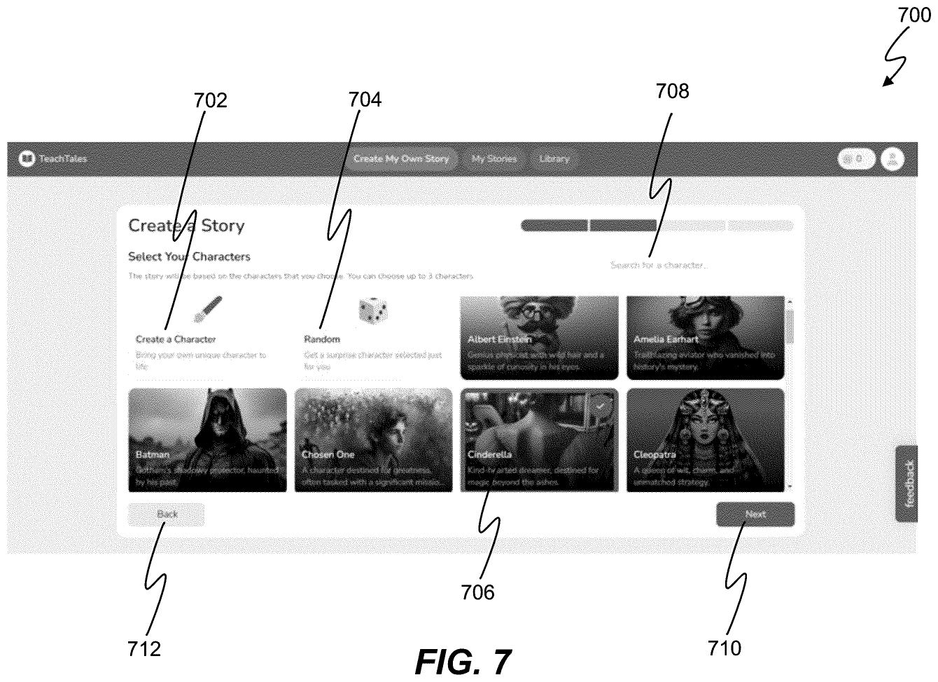

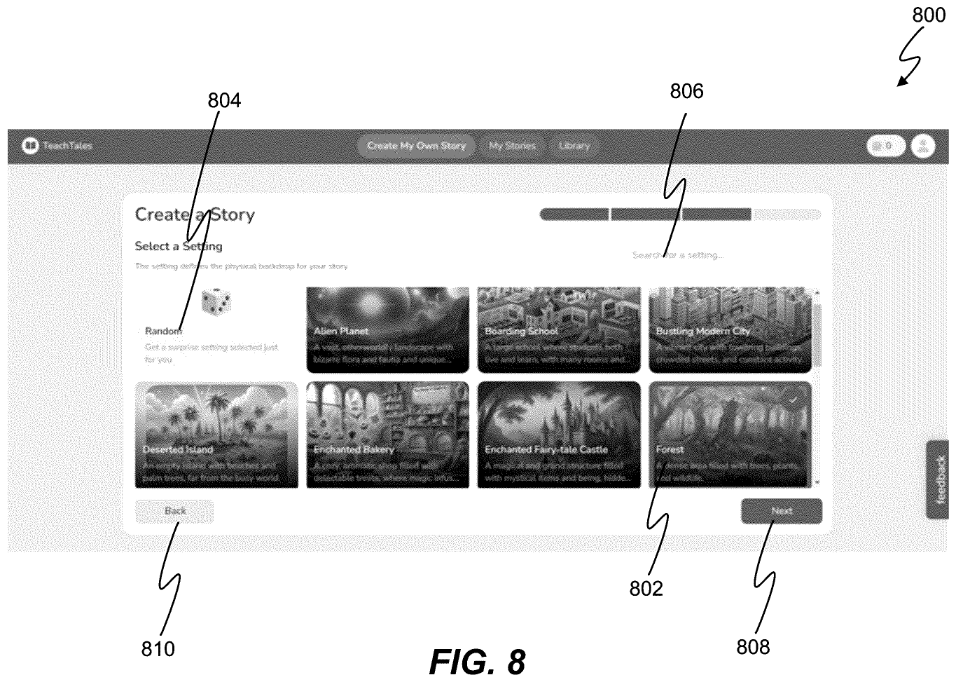

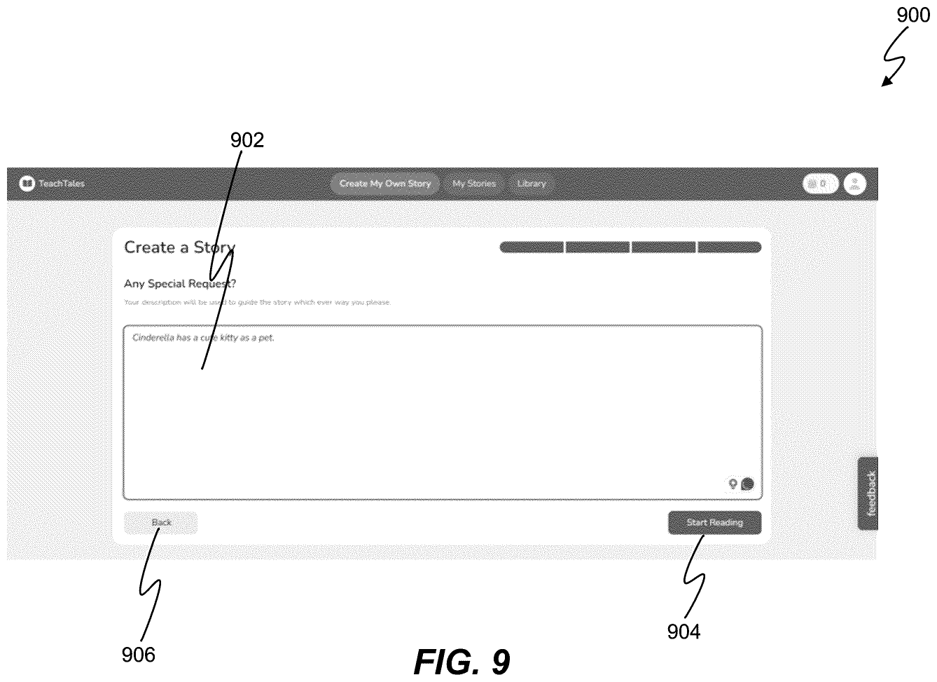

FIGS. 6-9 depict exemplary user interfaces that disclose the different types of genres, characters, settings, and any other special requests, which can be selected by the user for the generation of the personalized reading passage.

Upon clicking on the tab ‘Create a Story’ 506 on the user interface 500, the user is presented with the user interface 600, which allows the user to create a personalized passage by selecting the genre of his/her choice.

The user interface 600 shows a tab ‘Create my own Story’ 602, clicking on which multiple genres are made available to the user. The user can select the genre of his/her choice, by clicking on the corresponding tabs. For instance, the user can select genres like ‘Adventure’ 606, ‘Fantasy’ 608, ‘Mystery’ 610, ‘Science Fiction’ 612, and ‘Short Story’ 614. Interestingly, if the user is confused while selecting the genres, the user can click on the tab ‘Random’ 604, which allows random selection of any of the genres that will not be based on the user's interests.

Further, if the user wishes to select a genre other than the mentioned genres, the user can click on the tab ‘Search a Genre’ 618. Upon finalizing the genre, the user can click on the tab ‘Next’ 620 to go to the next page of the online learning platform 102. For instance, in the case of the present example, the user has selected the ‘Short Story’ 614 genre.

After selecting the ‘Short Story’ 614 genre from the user interface 600, the user interface 700 is made visible to the user.

In the user interface 700, the user is provided with multiple characters, which the user can select to make them a part of their personalized passage. Here, the user can either create a character of his/her own choice by clicking on the tab ‘Create a Character’ 702, or select the multiple characters already provided to the user. If the user clicks on the tab ‘Create a Character’ 702, the user has to provide details like what kind of character they want. The user can provide details related to the same, for instance, ‘A scientist with one leg doing chemistry experiments’ could be one prompt. Based on this prompt, the AI-driven reading passage generation system 100 will generate the image.

There are multiple characters displayed to the user on the user interface 700, like Albert Einstein, Amelia Earhart, Batman, Chosen One, Cinderella 706, Cleopatra, and so on. In the case of the present example, the user has selected ‘Cinderella’ 706.

Also, the user can tab ‘Random’ 706, if they are confused in selecting the character of the passage. Further, if the user wishes to select a character other than the mentioned characters, the user can click on the tab ‘Search a Character’ 708. Upon finalizing the character for the passage, the user can click on the tab ‘Next’ 710 to go to the next page of the online learning platform 102. The user can also use the tab ‘Back’ 712 to go back to the previous page of the online learning platform 102 if the user wishes to make any changes to the previous pages.

After selecting the ‘Cinderella’ 706 character for the passage from the user interface 700, the user interface 800 is presented to the user.

In the user interface 800, the user is provided with multiple location-based settings, which the user can select to create an environment for their personalized passage. Here, the user can select the location-based settings from the plurality of choices given like Alien Planet, Boarding School, Bustling Modern City, Deserted Island, Enchanted Bakery, Enchanted Fairy-Tale Castle, Forest 802, and so on. The user can select the location-based settings by clicking on the corresponding location-based settings. In the case of the present example, the user has selected ‘Forest’ 802.

Also, the user can tab ‘Random’ 804, if they are confused in selecting the location-based settings for the passage. Further, if the user wishes to select the location-based settings other than the given ones, the user can click on the tab ‘Search for a Setting’ 806. Upon finalizing the location-based settings for the passage, the user can click on the tab ‘Next’ 808 to go to the next page of the online learning platform 102. The user can also use the tab ‘Back’ 806 to go back to the previous page of the online learning platform 102 if the user wishes to make any changes to the previous pages.

After selecting the ‘Forest’ 802 location-based setting for the passage from the user interface 800, the user interface 900 is presented to the user.

The user interface 900 allows users to add any additional requests, besides, genre, characters, and location-based settings. The user can write the details in the block 902. For instance, in the case of the present example, the extra details provided by the user are ‘Cinderella has a cute kitty as a pet’.

Upon providing any further requests for the passage generation, the user can click on the tab ‘Next’ 904 to go to the next page of the online learning platform 102. The user can also use the tab ‘Back’ 906 to go back to the previous page of the online learning platform 102 if the user wishes to make any changes to the previous pages.

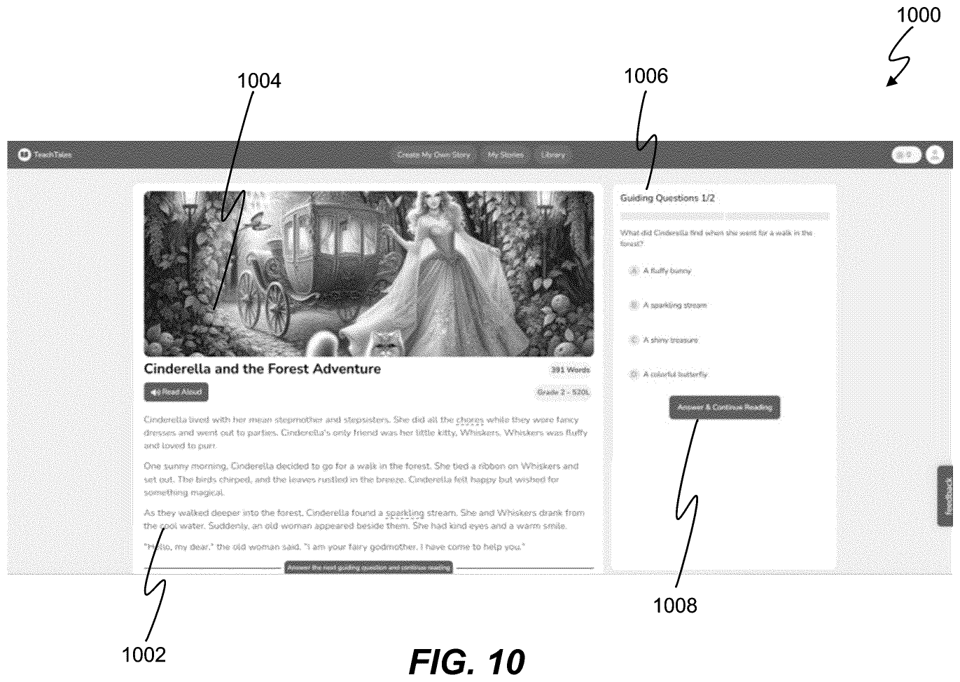

FIG. 10 depicts an exemplary user interface 1000 disclosing the generated reading passage for the user using an online learning platform 102.

The user interface 1000 shows the generated passage 1002 which is in the form of a story, along with an image 1004 corresponding to the generated passage 1002, and a MCQ (Multiple Choice Question) 1006. The user can read the generated passage 1002, answer the questions given 1006, and click on the tab ‘Answer and Continue Reading’ 1008 to generate the rest of the part of the generated passage 1002.

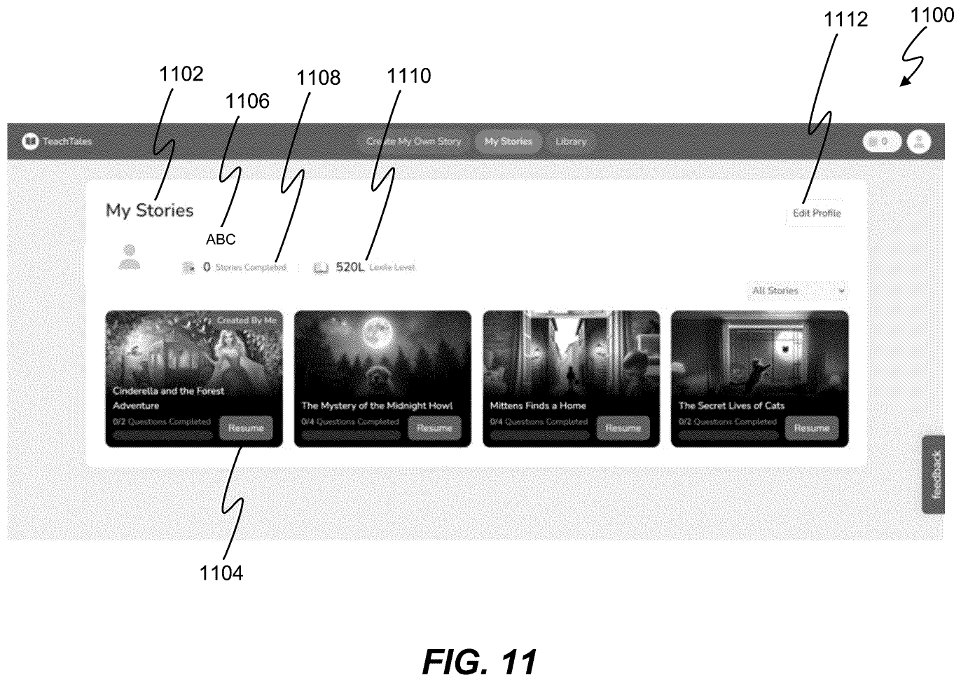

FIG. 11 depicts an exemplary user interface 1100 that discloses the collection of the reading passages that are generated by the user.

After logging in using the user interface 500, the user can select the tab ‘My Stories’ 1102 to see the collection of all the passages generated till date. The tab ‘User Name’ 1106 discloses the name of the user, following which tabs like ‘Stories Completed’ 1108, and ‘Lexile Level’ 1110 provide details of the passages completed by the user and lexile level or the reading level of the user based on which the passage is generated respectively. The user can click on the tab ‘Resume’ 1104 to resume reading the passages where they have left if the passage is left incomplete.

The ‘Lexile level’ 1110 can be either inputted by the user or keeps on updating on a real-time basis based on the interaction of the user with the online learning platform 102. The answers to question 1006 act as a criterion for the updation of the Lexile level or reading level of the user. If the user answers correctly, the lexile level increases, and vice versa.

If the user wishes to make any changes to the user profile 108, the user can click on the tab ‘Edit Profile’ 1112.

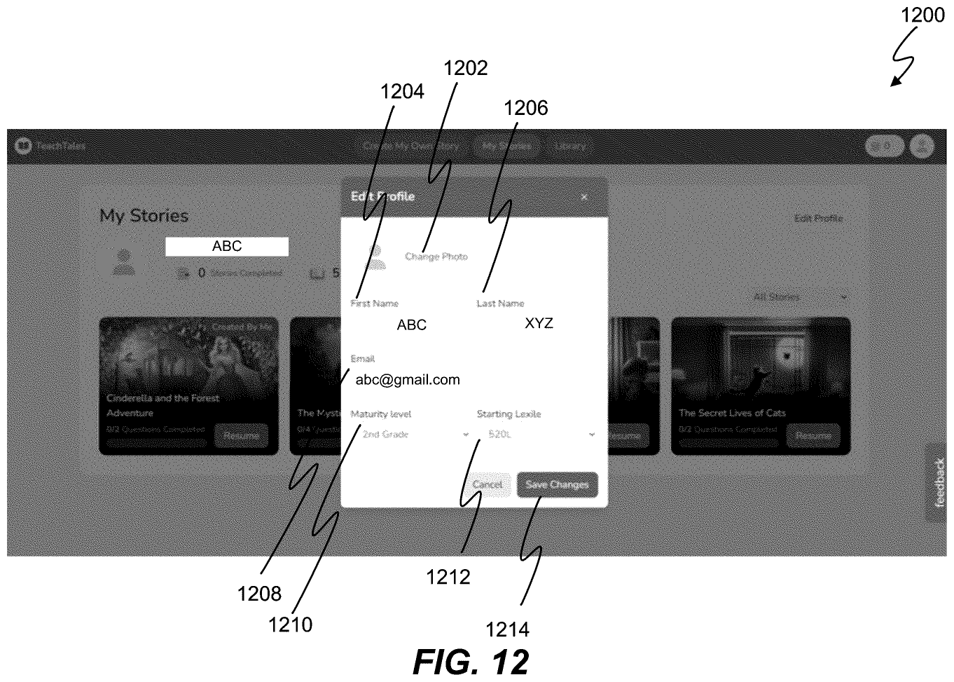

FIG. 12 depicts an exemplary user interface 1200 disclosing the edit profile option using which the user can make changes in the details given in the user profile 108.

Upon clicking on the tab ‘Edit Profile’ 1112, a user interface 1200 appears in front of the user. The user can make changes to their profile by clicking on various tabs provided on the user interface 1200. For instance, by clicking on the tab ‘Change Photo’ 1202, the user can change their photo, tab ‘First Name’ 1204, ‘Last Name’ 1206, and ‘e-mail’ 1208, the user can make changes in their name and email address respectively.

Further, the user can make changes to academic standards 114 by clicking on the tab ‘Maturity Level’ 1210, and the user reading level 112 by clicking on the tab ‘Starting Lexile’ 1212. After making the changes the user can click on the tab ‘Save Changes’ 1214.

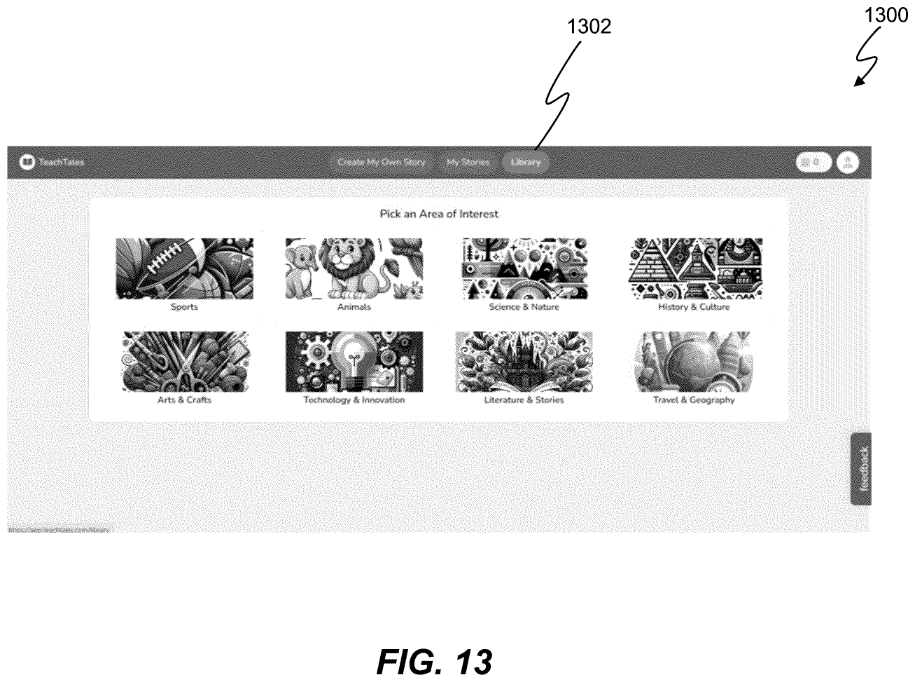

FIG. 13 depicts an exemplary user interface 1300 disclosing the areas of interest, which can be selected by the user for the generation of the personalized reading passage.

After logging in using the user interface 500, the user can select the tab ‘Library’ 1302 which provides the various topics to the user. By clicking on these topics the user can select the area of interest. For instance, the areas of interest include topics like Sports, Animals, Science & Nature, History & Culture, Art & Crafts, Technology & Innovation, Literature & Stories, Travel & Geography, and so on. The user can select the area of his/her choice for personalized passage generation.

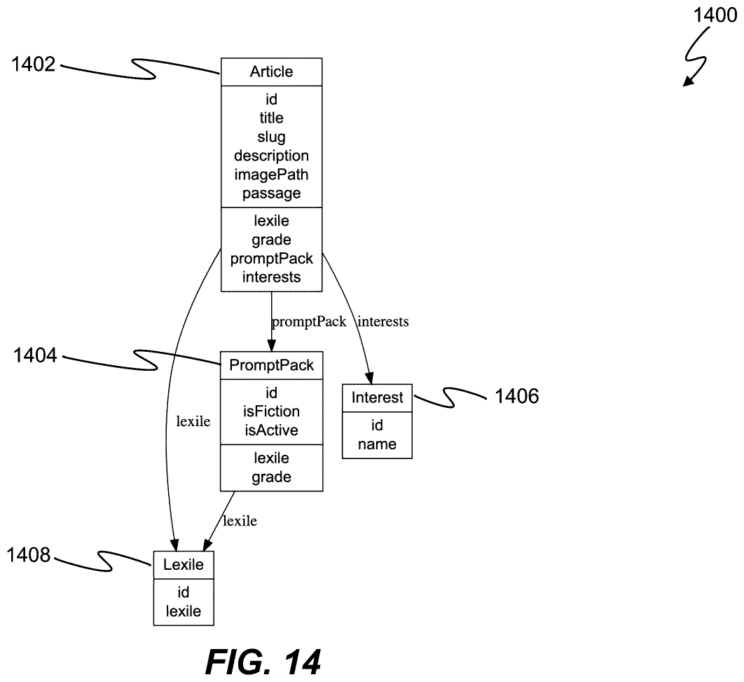

FIG. 14 depicts a data structure 1400 for organizing data to populate the prompt structure based on various inputs.

The data structure 1400 illustrates the relationships between various entities involved in generating personalized reading passages. The data structure 1400 includes four main nodes, namely, Article 1402, PromptPack 1404, Interest 1406, and Lexile 1408.

The Article node 1402 represents a reading passage and includes attributes such as id, title, slug, description, imagePath, and passage, along with references to its complexity level (Lexile) or user reading level 112, educational grade (grade), or academic standard 114, the prompt structure used to create promptPack 1404, and associated topics or themes (interests). The Lexile node 1408 contains the id and Lexile attributes and is linked to the Article node 1402, indicating the reading difficulty level of the article.

Similarly, the PromptPack node 1404 holds attributes like id, isFiction, isActive, lexile, and grade, and is connected to both the Article node 1402 and Lexile node 1404. This connection shows that each passage is generated using a specific prompt structure that aligns with its Lexile score and grade level. Finally, the Interest node 1406, representing the user's interests 110, is linked to the Article node 1402, tying each passage to relevant themes or topics that match the user's interests 110.

The data structure 1400 efficiently organizes how the reading passages are created, categorized, and personalized, ensuring that the reading passage is appropriate for the user's reading level and interests.

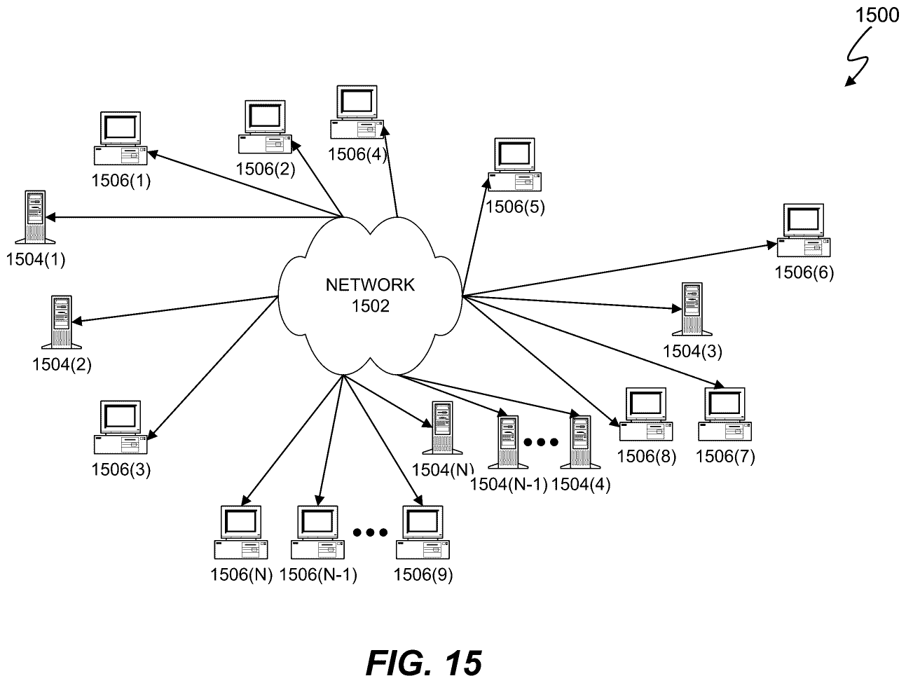

FIG. 15 is a block diagram illustrating a network environment in which an AI-driven reading passage generation system 100 and process 200 for a user using an online learning platform 102 may be practiced. Network 1502 (e.g. a private wide area network (WAN) or the Internet) includes several networked server computer systems 1504(1)-(N) that are accessible by client computer systems 1506(1)-(N), where N is the number of server computer systems connected to the network. Communication between client computer systems 1506(1)-(N) and server computer systems 1504(1)-(N) typically occurs over a network, such as a public switched telephone network over asynchronous digital subscriber line (ADSL) telephone lines or high-bandwidth trunks, for example, communications channels providing TI or OC3 service. Client computer systems 1506(1)-(N) typically access server computer systems 1504(1)-(N) through a service provider, such as an internet service provider (“ISP”) by executing application-specific software, commonly referred to as a browser, on one of client computer systems 1506(1)-(N).

Client computer systems 1506(1)-(N) and/or server computer systems 1504(1)-(N) are specialized computers programmed to improve conventional computer systems to implement and utilize the AI-driven reading passage generation system 100 and process 200 for a user using an online learning platform 102. The type of computer system that can be specially programmed to implement and utilize the AI-driven reading passage generation system 100 and process 200 for a user using an online learning platform 102 includes a mainframe, a mini-computer, a personal computer system including notebook computers, a wireless, mobile computing device (including personal digital assistants, smartphones, and tablet computers). These computer systems are typically designed to provide computing power to one or more users, either locally or remotely. Each computer system may also include one or a plurality of input/output (“I/O”) devices coupled to the system processor to perform specialized functions. Tangible, non-transitory memories (also referred to as “storage devices”) such as hard disks, compact disk (“CD”) drives, digital versatile disk (“DVD”) drives, and magneto-optical drives may also be provided, either as an integrated or peripheral device. In at least one embodiment, the AI-driven reading passage generation system 100 and process 200 for a user using an online learning platform 102 can be implemented using code stored in a tangible, non-transient computer-readable medium and executed by one or more processors. In at least one embodiment, the AI-driven reading passage generation system 100 and process 200 for a user using an online learning platform 102 can be implemented completely in hardware using, for example, logic circuits and other circuits including field programmable gate arrays.

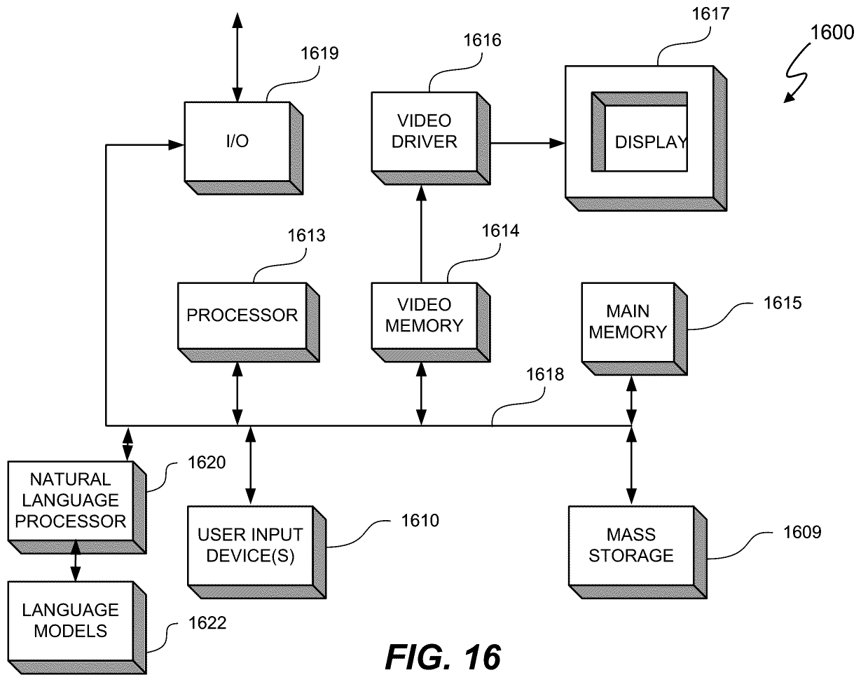

Embodiments of the AI-driven reading passage generation system 100 and process 200 for a user using an online learning platform 102 can be implemented on a computer system such as a special-purpose, special-programmed computer 1600 illustrated in FIG. 16. The input user device(s) 1610, such as a keyboard and/or mouse, are coupled to a bi-directional system bus 1618. The input user device(s) 1610 are for introducing user input to the computer system and communicating that user input to the processor 1613. The computer system of FIG. 16 generally also includes a non-transitory video memory 1614, non-transitory main memory 1615, and non-transitory mass storage 1609, all coupled to the bi-directional system bus 1618 along with input user device(s) 1610 and processor 1613. The mass storage 1609 may include both fixed and removable media, such as a hard drive, one or more CDs or DVDs, solid state memory including flash memory, and other available mass storage technology. Bus 1618 may contain, for example, 32 of 64 address lines for addressing video memory 1614 or main memory 1615. The system bus 1618 also includes, for example, an n-bit data bus for transferring DATA between and among the components, such as CPU 1609, main memory 1615, video memory 1614, and mass storage 1609, where “n” is, for example, 32 or 64. Alternatively, multiplex data/address lines may be used instead of separate data and address lines.

I/O device(s) 1619 may provide connections to peripheral devices, such as a printer, and may also provide a direct connection to a remote server computer system via a telephone link or to the Internet via an ISP. I/O device(s) 1619 may also include a network interface device to provide a direct connection to a remote server computer system via a direct network link to the Internet via a POP (point of presence). Such connection may be made using, for example, wireless techniques, including digital cellular telephone connection, Cellular Digital Packet Data (CDPD) connection, digital satellite data connection, or the like. Examples of I/O devices include modems, sound and video devices, and specialized communication devices such as the aforementioned network interface.

Computer programs and data are generally stored as code in a non-transient computer-readable medium such as flash memory, optical memory, magnetic memory, compact disks, digital versatile disks, and any other type of memory. The computer program is loaded from a memory, such as mass storage 1609, into main memory 1615 for execution. Computer programs may also be in the form of electronic signals modulated in accordance with the computer program and data communication technology when transferred via a network. In at least one embodiment, Java applets or any other technology is used with web pages to allow a user of a web browser to make and submit selections and allow a client computer system to capture the user selection and submit the selection data to a server computer system.

The processor 1613, in one embodiment, is a microprocessor manufactured by Motorola Inc. of Illinois, Intel Corporation of California, or Advanced Micro Devices of California. However, any other suitable single or multiple microprocessors or microcomputers may be utilized. Main memory 1615 consists of dynamic random access memory (DRAM). Video memory 1614 is a dual-ported video random access memory. One port of the video memory 1614 is coupled to the video amplifier 1616. The video amplifier 1616 is used to drive the display 1617. Video amplifier 1616 is well-known in the art and may be implemented by any suitable means. This circuitry converts pixel DATA stored in video memory 1614 to a raster signal suitable for use by display 1617. Display 1617 is a type of monitor suitable for displaying graphic images.

The computer system described above is for purposes of example only. The AI-driven reading passage generation system 100 and process 200 for a user using an online learning platform 102 may be implemented in any type of computer system or programming or processing environment. It is contemplated that the AI-driven reading passage generation system 100 and process 200 for a user using an online learning platform 102 based on the educational standards might be run on a stand-alone computer system, such as the one described above. The AI-driven reading passage generation system 100 and process 200 for a user using an online learning platform 102 might also be run from a server computer system that can be accessed by a plurality of client computer systems interconnected over an intranet network. Finally, the AI-driven reading passage generation system 100 and process 200 for a user using an online learning platform 102 may be run from a server computer system that is accessible to clients over the Internet.

Although embodiments have been described in detail, it should be understood that various changes, substitutions, and alterations can be made herein without departing from the spirit and scope of the invention as defined by the appended claims.

What is claimed is:

1. A method that integrates programmatic control and a guided and constrained Artificial Intelligence (AI) engine to generate a personalized reading passage for a user using an online learning platform, the method comprises:
executing code using one or more processors of a computer system to cause the computer system to perform operations comprising:
collecting user details from a user profile, and optional fictional attributes inputted by the user while using the online learning platform, wherein the user details include user interests, user reading level, and academic standard of the user for age appropriateness;
analyzing the collected user details and optional fictional attributes, and generating insights;
selecting a prompt structure from a prompt structure repository based on the genre and the reading level of the user;
generating prompts by populating the selected prompt structure by utilizing the analyzed insights to guide the AI engine to generate the reading passage;
transferring the generated prompts to the AI engine to generate the reading passage based on user interests, reading level, age appropriateness, and optional fictional attributes;
generating the personalized reading passage along with MCQ questions, a title for the reading passage, and an associated image for the reading passage.

2. The method of claim 1 wherein the optional fictional attributes inputted by the user while using the online learning platform includes settings related to location and environment, characters, plot, and twist.

3. The method of claim 2 further comprises:
selecting specific fictional attributes including setting, characters, plot, and twist by the user;
integrating the selected fiction attributes into the prompt structure during the customization process to create a comprehensive prompt that enhances personalization;
generating the fictional reading content by incorporating the selected fiction attributes, ensuring that the generated reading passage elements align with the user's interests;

4. The method of claim 1, wherein the user's reading level is initially set by default according to the user's age, is determined based on the academic standard of the user.

5. The method of claim 1 further comprises:
monitoring and analyzing user's reading behavior, including, accuracy in answering questions, and time taken in completing the passage.

6. The method of claim 1 wherein the user's reading level keeps on updating as the user interacts with the online learning platform.

7. The method of claim 1 wherein the reading passage is stored in a cloud database for subsequent retrieval.

8. The method of claim 1 wherein the generated personalized reading passage along with MCQ questions, a title for the reading passage, and an associated image for the reading passage are displayed to the user on a user interface of the online learning platform via a display module.

9. The method of claim 1 wherein personalizing the generated passage using machine learning algorithms further comprises:
tracking the user's reading performance and analyzing the genre and themes of the user's interests;
generating the reading passage in correspondence to the user's interests, and complexity that the user can face.

10. The method of claim 1 wherein a real-time feedback is provided to the user based on the reading performance of the user.

11. The method of claim 1 wherein the reading level keeps on changing on a real-time basis based on the interaction of the user with the online learning platform, and the answers provided by the user for the generated questions.

12. A system that integrates programmatic control and a guided and constrained Artificial Intelligence (AI) engine to generate a personalized reading passage for a user using an online learning platform, the system comprising:
one or more processors of a computer system; and
a memory, coupled to the one or more processors, storing code that when executed causes the computer system to perform operations comprising:
collecting user details from a user profile, and optional fictional attributes inputted by the user while using the online learning platform using a data collector, wherein the user details include user interests, user reading level, and academic standard of the user for age appropriateness;
analyzing the collected user details and optional fictional attributes, and generating insights using an analyzer;
selecting a prompt structure from a prompt structure repository using a selector based on the genre and the reading level of the user;
generating prompts using a prompt generator by populating the selected prompt structure by utilizing the analyzed insights to guide the AI engine to generate the reading passage;
transferring the generated prompts to the AI engine to generate the reading passage based on user interests, reading level, age appropriateness, and optional fictional attributes;
generating the personalized reading passage using a passage generator, along with MCQ questions, a title for the reading passage, and an associated image for the reading passage.

13. The system of claim 12 wherein the generated reading passage is displayed to the user on a user interface integrated within the online learning platform.

14. The system of claim 12 wherein the data collector updates the user details in real-time based on user interactions with the online learning platform.

15. The system of claim 12 wherein the prompt structure repository is categorized by genre and reading level, and the selector chooses a prompt structure from the repository based on a match between the user's genre preference and reading level.

16. The system of claim 12 wherein the MCQ questions are generated to evaluate the user's comprehension of the reading passage and are in correspondence with the key concepts identified in the passage.

17. The system of claim 12 wherein the AI engine uses natural language processing to adapt the reading passage content based on user preferences and previous interactions with the online learning platform.

18. The system of claim 12 provides a real-time feedback using a feedback module to the user based on the reading performance of the user.
